(19) United States
(12) Patent Application Publication
(10) Pub. No.: US 2025/0256239 A1
(43) Pub. Date: Aug. 14, 2025

(54) DEHUMIDIFYING APPARATUS

(71) Applicant: Mitsubishi Electric Corporation, Tokyo (JP)

(72) Inventors: Atsushi MORITA, Tokyo (JP); Tsuyoshi MAEDA, Tokyo (JP); Shin NAKAMURA, Tokyo (JP); Akira YATSUYANAGI, Tokyo (JP)

(21) Appl. No.: 18/702,400

(22) PCT Filed: Dec. 9, 2021
(86) PCT No.: PCT/JP2021/045277

§ 371 Date: Apr. 18, 2024

(51) Int. Cl. B01D 53/26; F24F 1/0083

(52) U.S. Cl. CPC B01D 53/265; F24F 1/0083; B01D 2257/80

(57) ABSTRACT

A dehumidifying apparatus according to the present disclosure includes: a housing; an air inlet provided in the housing; an air outlet provided in the housing; a blower provided in the housing; and an evaporator provided on an air passage that connects the air inlet and the air outlet, and configured to cool and dehumidify air that is sent into the housing by the blower. The evaporator includes a plurality of flat tubes having flow passages through which refrigerant flows and extending in an up-down direction, a pair of headers connected to an upper end and a lower end of each of the flat tubes, and a first extension portion connected to a windward side of one of the flat tubes, and having long sides extending in the up-down direction along of the flat tube.

### CROSS REFERENCE TO RELATED APPLICATION

This application is a U.S. national stage application of PCT/JP2021/045277 filed on Dec. 9, 2021, the contents of which are incorporated herein by reference.

### TECHNICAL FIELD

The present disclosure relates to a dehumidifying apparatus.

### BACKGROUND

In the past, dehumidifying apparatuses have been provided that include an evaporator configured to dehumidifies air having moisture by cooling the air and a condenser configured to reheat the air. The evaporator and the condenser are both fin-and-tube type circular heat exchangers.

### PATENT LITERATURE

Patent Literature 1: Japanese Unexamined Patent Application Publication No. Hei 7-294179

When the humidity in a room rises, a resident may feel uncomfortable or a hygienic environment in the room may deteriorate, especially in the summer. However, in order to enhance a dehumidification performance, a dehumidifying apparatus disclosed in Patent Literature 1 needs an evaporator in which a larger number of tubes are arranged in a row, and as a result, the size and weight of the dehumidifying apparatus are increased, and noise is made due to an increase in a blowing pressure.

### SUMMARY

The present disclosure is applied to solve the above problems, and relates to a dehumidifying apparatus that can be made to have a smaller size and a lower weight and also can reduce noise made from the dehumidifying apparatus, while having a dehumidification performance higher than or equivalent to that of an existing dehumidifying apparatus.

A dehumidifying apparatus according to an embodiment of the present disclosure includes: a housing; an air inlet provided in the housing; an air outlet provided in the housing; a blower provided in the housing; and an evaporator provided on an air passage that connects the air inlet and the air outlet, and configured to cool and dehumidify air that is sent into the housing by the blower. The evaporator includes a plurality of flat tubes having flow passages through which refrigerant flows and extending in an up-down direction, a pair of headers connected to an upper end and a lower end of each of the flat tubes, and a first extension portion connected to a windward side of one of the flat tubes, and having long sides extending in the up-down direction along of the flat tube.

By using, as the evaporator, a finless heat exchanger that is superior in drainage performance, it is possible to reduce the size and weight of the dehumidifying apparatus according to the embodiment of the present disclosure, and reduce noise to a low level, while keeping the dehumidification performance of the dehumidifying apparatus equivalent to that of an existing dehumidifying apparatus.

### BRIEF DESCRIPTION OF DRAWINGS

FIG. 1 illustrates a configuration of a dehumidifying apparatus according to Embodiment 1.

FIG. 2 illustrates a refrigerant circuit according to Embodiment 1.

FIG. 3 illustrates configurations of heat exchangers in Embodiment 1.

FIG. 4 illustrates a configuration of an existing flat-tube heat exchanger.

FIG. 5 is a diagram indicating performances of a heat exchanger in Embodiment 1.

FIG. 6 is a diagram indicating a temperature distribution of the heat exchanger in Embodiment 1.

FIG. 7 is a diagram indicating another performance of the heat exchanger in Embodiment 1.

FIG. 8 illustrates configurations of heat exchangers in an existing dehumidifying apparatus.

FIG. 9 illustrates configurations of a heat exchanger in Embodiment 2.

FIG. 10 is a diagram indicating a temperature distribution of the heat exchanger in Embodiment 1.

FIG. 11 illustrates configurations of heat exchangers in Embodiment 3.

FIG. 12 illustrates a modification of the heat exchanger in Embodiment 3.

FIG. 13 illustrates configurations of a heat exchanger in Embodiment 4.

FIG. 14 illustrates a configuration of a dehumidifying apparatus according to Embodiment 4.

FIG. 15 illustrates a configuration of a heat exchanger in Embodiment 5.

### DETAILED DESCRIPTION

The embodiments of the present disclosure will be described with reference to figures in the drawings. In each of the figures, components that are the same as those in a previous figure or previous figures are denoted by the same reference sings (1a, 1b, . . . ). Furthermore, in the following description, of the above components, components that do not need be distinguished from each other are denoted by reference signs not including suffixes.

The following description is made to explain the embodiments, and are not limiting. That is, a person with ordinary skill in the art can replace each or all of elements of a dehumidifying apparatus descried in the present disclosure with an equivalent or equivalents, and adopt the equivalents, and the equivalents are also encompassed in the scope of the present disclosure. That is, the present disclosure is not limited to the embodiments that will be described below but may be modified variously without departing from the gist of the present disclosure.

### Embodiment 1

### Configuration of Dehumidifying Apparatus

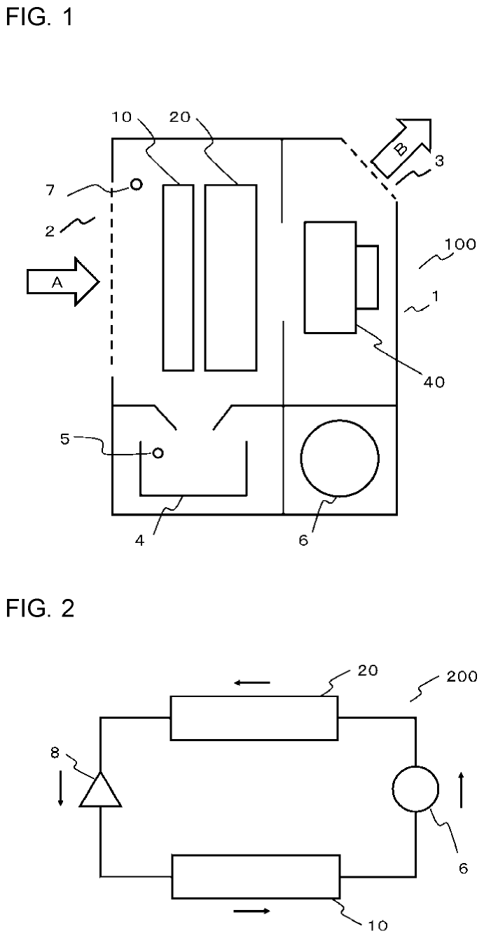

FIG. 1 illustrates a configuration of a dehumidifying apparatus 100 according to Embodiment 1 of the present disclosure. As illustrated in FIG. 1, the dehumidifying apparatus 100 includes a housing 1 that is kept up with no support. The housing 1 has an air inlet 2 through which indoor air A (hereinafter referred to as “air A”) flows into the housing 1 and an air outlet 3 through which dry air B (hereinafter referred to as “air B”) flows out from the housing 1 into a room.

In the housing 1, an evaporator 10 is provided downstream of the air inlet 2 and a condenser 20 is provided downstream of the evaporator 10. Therefore, the air A sucked through the air inlet 2 flows into the condenser 20 after passing through the evaporator 10.

Furthermore, in the housing 1, a blower 40 is provided. The blower 40 sucks the air A into the housing 1 through the air inlet 2, causes the air A to pass through the evaporator 10 and the condenser 20, and then causes the air B to flow out into the room through the air outlet 3. It should be noted that any type of blower such as a sirocco fan or a propeller fan can be used as the blower 40.

In the housing 1, a water storage tank 4 is provided in which moisture removed from the air A by the evaporator 10 is stored. The water storage tank 4 is, for example, a plastic cuboid having an open top. Furthermore, the water storage tank 4 can be removed from the housing 1 to the outside of the housing 1 through a slot (not illustrated) provided in the housing 1. A user can remove the water storage tank 4 from the housing 1 and pour off the water stored in the water storage tank 4, as occasion arises.

Furthermore, at the water storage tank 4, a water level sensor 5 is provided as a water amount detector configured to detect the amount of water in the water storage tank 4. As the water level sensor 5, an optical water level sensor including a light-emitting element and a light-receiving element, an ultrasonic water level sensor including an ultrasonic emitting circuit and an ultrasonic receiving circuit, or other sensors can be used.

In addition, in the housing 1, a compressor 6 is provided. It is preferable that a space in the housing 1 in which the compressor 6 is housed be partitioned by partition walls into a space in which the evaporator 10 and the condenser 20 are housed, a space in which the water storage tank 4 is housed, and a space in which the blower 40 is housed. This is intended to prevent exhaust heat from the compressor 6 from affecting the operation of other elements and deteriorating material of the other elements.

Furthermore, in the housing 1, a temperature and humidity sensor 7 is provided to detect the temperature and humidity of the air A. The temperature and humidity sensor 7 is provided between the air inlet 2 and the evaporator 10. However, preferably, the temperature and humidity sensor 7 should be provided close to the air inlet 2 in order to prevent the result of detection by the temperature and humidity sensor 7 from being affected by air cooled in the evaporator 10.

The temperature and humidity sensor 7 is an integrated combination of a temperature sensor and a humidity sensor. However, the temperature sensor and the humidity sensor may be provided as separate members. Furthermore, in the dehumidifying apparatus 100, a communication module may be provided to communicate with an air-conditioning apparatus that is installed in the same room as the dehumidifying apparatus 100, receive the temperature and humidity of air that are measured by the air-conditioning apparatus, and regard the temperature and the humidity as the temperature and humidity of the air A.

FIG. 2 illustrates a refrigerant circuit 200 mounted in the dehumidifying apparatus 100. As illustrated in FIG. 2, the refrigerant circuit 200 includes the compressor 6, the condenser 20, an expansion unit 8, and the evaporator 10. These components included in the refrigerant circuit 200 are connected to each other by copper pipes or other kinds of pipes. Refrigerant such as R134a, R410A, R290, R1234yf, or R1234ze flows in the refrigerant circuit 200.

The compressor 6 is a certain type of compressor, such as a piston type compressor, a rotary type compressor, or a scroll type compressor. Furthermore, the expansion unit 8 is a certain kind of expansion module such as an expansion valve or a capillary tube.

The compressor 6, the expansion unit 8, the blower 40, the water level sensor 5, and the temperature and humidity sensor 7 are connected to a controller (not illustrated). The controller controls operations of the compressor 6, the expansion unit 8, and the blower 40. Furthermore, the controller acquires, from the water level sensor 5 and the temperature and humidity sensor 7, information necessary for control of the compressor 6, the expansion unit 8, and the blower 40. In the case where the expansion unit 8 is a capillary tube, the controller does not exercise control.

It should be noted that the controller may include an inverter circuit configured to control the compressor 6. The inverter circuit is a circuit configured to convert a DC voltage obtained by conversion by the inverter circuit into an AC voltage having a given voltage value, a given frequency, and a given phase. Because the inverter circuit is provided, the operating frequency [Hz] of the compressor 6 is adjusted to an optimum value depending on the state of the air A and a requisite amount of dehumidification. As a result, it is possible to increase the flow rate of refrigerant, especially in the case where the amount of dehumidification increases. Therefore, it is possible to achieve a desired amount of dehumidification even when the amount of refrigerant that is filled into the refrigerant circuit 200 is reduced.

It should be noted that the controller may be hardware such as a circuit device that fulfills the functions of the controller, or be made up of an arithmetic device, such as a microcomputer or a CPU, and software that is run on the arithmetic device.

In the housing 1, a display panel (not illustrated) and control buttons (not illustrated) are provided. The user depresses control buttons to determine an operating condition of the dehumidifying apparatus 100, and the display panel indicates an operating state of the dehumidifying apparatus 100. Instead of the display panel and the control buttons provided in the housing 1, for example, a display panel and control buttons that are displayed via a dedicated application on a smartphone possessed by the user may be used. In this case, the user can operate the dehumidifying apparatus 100 or check the operating state, based on content displayed on the smartphone.

### Configuration of Heat Exchanger

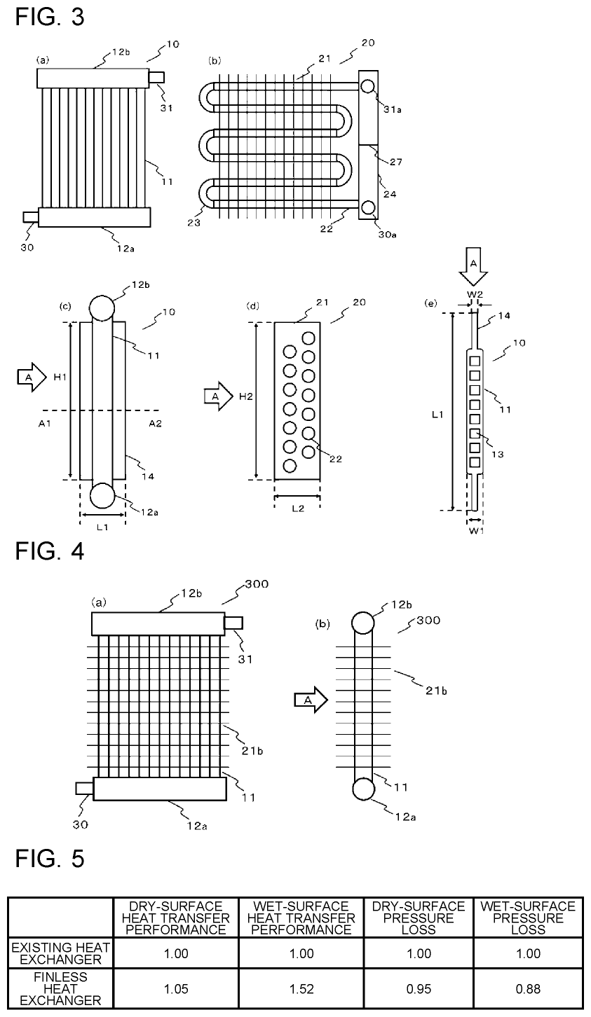

FIG. 3 illustrates configurations of the evaporator 10 and the condenser 20. To be more specific, FIG. 3, (a), is a front view of the evaporator 10. FIG. 3, (b), is a front view of the condenser 20. FIG. 3, (c), is a side view of the evaporator 10. FIG. 3, (d), is a side view of the condenser 20. FIG. 3, (e), is a cross-sectional view of the evaporator 10 that is taken along line A1-A2. The “front view” is a view obtained as seen in the flow direction of air in FIG. 1, and the “side view” is a view obtained as seen in a direction perpendicular to the flow direction of air.

As illustrated in FIG. 3, (a) and (c), the evaporator 10 includes flat tubes 11 (elongated heat transfer tubes), headers 12a and 12b connected to both ends of each of the flat tubes 11, and extension portions 14 connected to the flat tube 11. Furthermore, to the header 12a, a first inlet tube 30 through which refrigerant is introduced into the header 12a is attached, and to the header 12b, a first outlet tube 31 through which the refrigerant is discharged from the header 12b is attached.

Each of the flat tubes 11 is an elongated tube extending in an up-down direction and includes a plurality of flow passages through which the refrigerant flows. In the example illustrated in FIG. 3, (e), the flat tube 11 includes twelve rectangular flow passages 13 arranged in an equidistant manner. Furthermore, the flat tube 11 is made of an aluminum alloy or other material that has high heat conductivity.

As illustrated in FIG. 3, (c) and (e), to a windward side and a leeward side of each of the flat tubes 11, respective extension portions 14 are connected. As illustrated in FIG. 3, (e), each of the extension portions 14 is a thin plate-shaped member, and unlike the flat tube 11, the extension portion 14 includes no refrigerant flow passage. Furthermore, as illustrated in FIG. 3, (c), the extension portion 14 has a long side connected to the flat tube 11 and short sides extending in the flow direction of air. The extension portion 14 is made of the same aluminum alloy or other material as the flat tube 11.

It is preferable that the width W2 of the extension portion 14 be smaller than the width W1 of the flat tube 11. This is because in the case where the width W2 of the extension portion 14 located on a windward side relative to the flat tube 11 is greater than the width W1 of the flat tube 11, the velocity of air over a surface of the flat tube 11 decreases and the amount of heat exchange at the flat tube 11 decreases. In contrast, in the case where the width W2 is smaller than the width W1, the velocity of air that flows over the surface of the flat tube 11 can be kept high, and the amount of heat exchange at the flat tube 11 can be kept large. For this reason, it is preferable that the width W2 of the extension portion 14 be smaller than the width W1 of the flat tube 11.

The header 12a and the header 12b are hollow circular tubes. Both ends of the flat tube 11 are connected to the header 12a and the header 12b. Furthermore, the flow passages 13 formed in the flat tube 11 communicate with internal spaces of the header 12a and the header 12b.

It should be noted that the header 12a may have a function of distributing the refrigerant. For example, the header 12a may be configured such that a dispersion tube including a plurality of dispersing holes is provided inside the hollow circular tube. In such a manner, in the case where the header 12a is made to have the above distributing function, it is possible to equalize the amounts of refrigerant that flows into the passages 13 of the flat tube 11, thereby increasing the amount of heat exchange at the evaporator 10.

Furthermore, the first inlet tube 30 is connected to one end of the header 12a, and the first outlet tube 31 is connected to one end of the header 12b. The first inlet tube 30 and the first outlet tube 31 are hollow circular tubes. The first inlet tube 30 communicates with a space in the header 12a, and the first outlet tube 31 communicates with a space in the header 12b.

It will be described how an existing flat-tube heat exchanger and the evaporator 10 are different in configuration from each other. FIG. 4 illustrates a configuration of the existing flat-tube heat exchanger 300. The heat exchanger 300 includes a plurality of flat tubes 11, a plurality of heat transfer fins 21b, and headers 12a and 12b connected to both ends of each of the flat tubes 11. In the exiting flat-tube heat exchanger 300, the thin-plate-shaped heat transfer fins 21b are connected as heat-transfer enhancement portions to the flat tubes 11 and the heat transfer fins 21 are provided perpendicular to the flat tubes 11, which extend in the up-down direction, and thus cross the flat tubes 11. In contrast, in the evaporator 10, the flat tube 11 is provided with the extension portions 14 that extend in the up-down direction as heat-transfer enhancement portions and no heat transfer fins are provided in a direction crossing an extending direction of the flat tubes 11. In other words, the difference between the configuration of the existing flat-tube heat exchanger 300 and that of the evaporator 10 resides in whether a heat transfer enhancement portion is provided in such a manner as to cross the flat tube 11 or is provided along the extending direction of the flat tube 11.

Next, a configuration of the condenser 20 will be described. As illustrated in FIG. 3, (b) and (d), the condenser 20 includes the heat transfer fins 21 serving as heat transfer enhancement portions, circular tubes 22 through which the refrigerant flows, hairpin tubes 23 connecting the circular tubes 22, and a header 24 connected to the circular tubes 22. Furthermore, in the header 24, a partition wall 27 is provided to divide the header 24 into upper and lower portions thereof. Furthermore, a second inlet tube 30a is connected to the lower portion of the header 24, which is located below the partition wall 27, and a second outlet tube 31a is connected to the upper portion of the header 24, which is located above the partition wall 27.

Each of the heat transfer fins 21 is formed of a highly thermally conductive metal such as an aluminum alloy and formed in the shape of a thin plate. The heat transfer fin 21 has a plurality of holes through which the circular tubes 22 pass. The heat transfer fins 21 are provided parallel to each other.

The circular tubes 22 are, for example, hollow circular tubes made of copper. The circular tubes 22 are provided to extend through holes provided in the heat transfer fin 21, and the circular tubes 22 and the heat transfer fin 21 are fixed to each other by blazing. That is, the circular tubes 22 and the heat transfer fin 21 are thermally connected to each other. Furthermore, the circular tubes 22 are connected to each other by the hairpin tubes 23. In the example as illustrated in FIG. 3, (b), a single long tube including folded members penetrates the plurality of heat transfer fins 21.

The header 24 is, for example, a hollow circular tube made of copper, and the inside of the header 24 is partitioned into upper and lower portions by the partition wall 27. As illustrated in FIG. 3, (b), an end of the lowermost one of the circular tubes 22 is connected to lower part of the header 24, and an end of the uppermost one of the circular tubes 22 is connected to upper part of the header 24. Furthermore, the second inlet tube 30a is connected to the lower part of the header 24, and the second outlet tube 31a is connected to the upper part of the header 24.

### Operation of Dehumidifying Apparatus

An operation of the dehumidifying apparatus 100 will be described. The controller of the dehumidifying apparatus 100 controls the operations of the compressor 6, the expansion unit 8, and the blower 40 based on an operating condition that is determined when the user depresses the control buttons and the results of detection by the water level sensor 5 and the temperature and humidity sensor 7.

First, when the water level sensor 5 detects that a predetermined or larger amount of water is stored in the water storage tank 4, the controller does not cause any of the compressor 6, the expansion unit 8, and the blower 40 to operate. Furthermore, the controller causes the display panel to make a display indicating that the predetermined or larger amount of water is stored in the water storage tank 4. In such a manner, the dehumidifying apparatus 100 prompts the user to pour off the water stored in the water storage tank 4.

When the water level sensor 5 detects that the predetermined or larger amount of water is stored in the water storage tank 4 during operation of the dehumidifying apparatus 100, the controller suspends the operations of the compressor 6, the expansion unit 8, and the blower 40 and causes the display panel to make the above display. As a result, there is no possibility that water will overflow from the water storage tank 4 during operation of the dehumidifying apparatus 100.

In contrast, in the case where the amount of water stored in the water storage tank 4 is less than the predetermined amount of water, the controller controls the frequency of the compressor 6, the opening degree of the expansion unit 8, and the rotation speed of the blower 40 to cause a humidity detected by the temperature and humidity sensor 7 to be lower than or equal to a humidity set by input using the control buttons.

More specifically, the controller determines a target dehumidification amount from the difference between the humidity first detected by the temperature and humidity sensor 7 and the set temperature. When the target dehumidification amount is less than a predetermined value (for example, 1 [g/kg (DA)]), the controller does not cause the compressor 6 to operate. In contrast, when the target dehumidification amount is larger than or equal to the predetermined value, the controller causes the compressor 6 to operate at a predetermined frequency.

Furthermore, in the case where the controller is provided with the inverter circuit and the frequency of the compressor 6 can be arbitrarily changed, the compressor 6 may be controlled in the following manner. When the target dehumidification amount is less than the predetermined value, the compressor 6 is operated at a frequency A Hz, and when the target dehumidification amount is larger than or equal to the predetermined value, the compressor 6 is operated at a frequency B Hz (B>A). The method of controlling the compressor 6 is not limited to the above method in which the compressor 6 is controlled at two frequencies, but the number of frequencies at which the compressor 6 is controlled may be larger than two.

Similarly, the controller controls the opening degree of the expansion unit 8. Specifically, when the target dehumidification amount is smaller than the predetermined value, the opening degree (pressure drop) of the expansion unit 8 is decreased, and when the target dehumidification amount is larger than or equal to the predetermined value, the opening degree of the expansion unit 8 is increased. Similarly, the controller determines the rotation speed [rmp] of the blower 40 based on the target dehumidification amount. It is preferable that the opening degree of the expansion unit 8 and the rotation speed of the blower 40 be controlled in multiple stages based on the target dehumidification amount.

Once the compressor 6, the expansion unit 8, and the blower 40 start to operate as described above, the refrigerant starts to circulate in the refrigerant circuit 200, and air also starts to be sucked into the housing 1. In the following description, the circulation of the refrigerant in the refrigerant circuit 200 is first referred to, and the change of the state of air in the housing 1 is then referred to.

First, the refrigerant is compressed in the compressor 6. High-temperature and high-pressure gas refrigerant obtained through compression by the compressor 6 flows into the condenser 20. The refrigerant that has flowed into the condenser 20 transfers heat to surrounding air to liquefy. The refrigerant that has liquefied is decompressed by the expansion unit 8 to change into two-phase gas-liquid refrigerant and then flows into the evaporator 10. The refrigerant that has flowed into the evaporator 10 receives heat from the surrounding air to change into gas refrigerant. Then, the gas refrigerant that has a low temperature and a low pressure flows out from the evaporator 10 and returns to the compressor 6.

The flow of refrigerant in the evaporator 10 will be described in more detail. As illustrated in FIG. 3, (a), (c), and (e), the evaporator 10 includes the header 12a, the flat tubes 11, and the header 12b. The two-phase gas-liquid refrigerant obtained through decompression by the expansion unit 8 flows into the header 12a through the first inlet tube 30. The refrigerant that has flowed into the header 12a branches into refrigerant streams to flow into the flow passages 13 of the flat tube 11, and the refrigerant streams then join each other in the header 12b. In the case where the header 12a has a function of distributing refrigerant, the header 12a can equalize the amounts of refrigerant streams that flow into the flow passage 13 of the flat tube 11, whereby the amount of heat exchange at the evaporator 10 is increased.

The state of air in the housing 1 will then be described. When the blower 40 operates, the air A is sent to the evaporator 10 in the housing 1 through the air inlet 2. It should be noted that the flat tubes 11 and the extension portions 14 are cooled by the refrigerant that flows through the flow passages 13. Therefore, the air A sent to the evaporator 10 is cooled by the flat tubes 11 and the extension portion 14, and moisture condenses on the flat tubes 11 and the extension portions 14, and the air A is dehumidified. The moisture that has condensed moves downward along the flat tubes 11 and the extension portions 14, drops from the evaporator 10, and is stored in the water storage tank 4.

In such a manner, indoor air is cooled, deceases in humidity, and is dehumidified. The dehumidified air is heated at the condenser 20 and flows out as humidity-controlled air B into the room through the air outlet 3.

Dehumidification at the evaporator 10 will be described in more detail. In the evaporator 10, moisture contained in the air A condenses on the flat tubes 11 and the extension portions 14. That is, after being dehumidified, the moisture adheres to the flat tubes 11 and the extension portions 14. It should be noted that in order to increase the dehumidification amount of the dehumidifying apparatus 100, it is necessary to enhance the heat exchange performance of the evaporator 10 and increase the amount of water that condenses per unit time.

FIG. 5 is a diagram indicating a dry-surface heat transfer performance, a wet-surface heat transfer performance, a dry-surface pressure loss, and a wet-surface pressure loss of a finless heat exchanger that is used as the evaporator 10, with reference to those of an existing heat exchanger. FIG. 5 illustrates relative values of the above items to values of the items of the existing heat exchanger that are each determined as 1.00. The existing heat exchanger is a fin and tube heat exchanger, such as the condenser 20 as illustrated in FIG. 3, (b) and (d), which includes circular tubes and heat transfer fins. More specifically, the heat transfer tubes are circular tubes each having a diameter of 7 mm, and are arranged in a row in the flow direction of air and arranged at a plurality of stages such that the stages are arranged at a stage pitch 21 mm, and the heat transfer fins each have a thickness of 0.1 mm and are arranged at a fin pitch of 1.5 mm. It should be noted that the heat transfer area ratio of the finless heat exchanger to the heat transfer area of the fin and tube heat exchanger for use in the measurement of the values indicated in FIG. 5 is 81%.

As indicated in FIG. 5, the finless heat exchanger exhibits a higher heat transfer performance than the existing heat exchanger on both a dry surface and a wet surface. Especially in the case where the surface is a wet surface, the finless heat exchanger exhibits a remarkably high performance as compared with the case where the surface is a dry surface. It will be described why the finless heat exchanger thus exhibits a high performance in the case where the surface is a wet surface.

During operation of the dehumidifying apparatus 100, condensed water adheres to a surface of the evaporator 10. The condensed water is discharged downward along the flat tubes 11 and the extension portions 14, since the flat tubes 11 and the extension portions 14 extend in the up-down direction. It should be noted that the condensed water is promptly discharged, because the evaporator 10 has no elements that hinder discharge of the condensed water, such as heat transfer fins provided to extend in the horizontal direction. In contrast, in the case where a fin and tube heat exchanger, such as the condenser 20, which includes heat transfer fins and circular tubes, is used as an evaporator, the circular tubes are elements that hinder discharge of dew condensation water. Accordingly, the evaporator 10 has a higher drainage performance than the fin and tube heat exchanger.

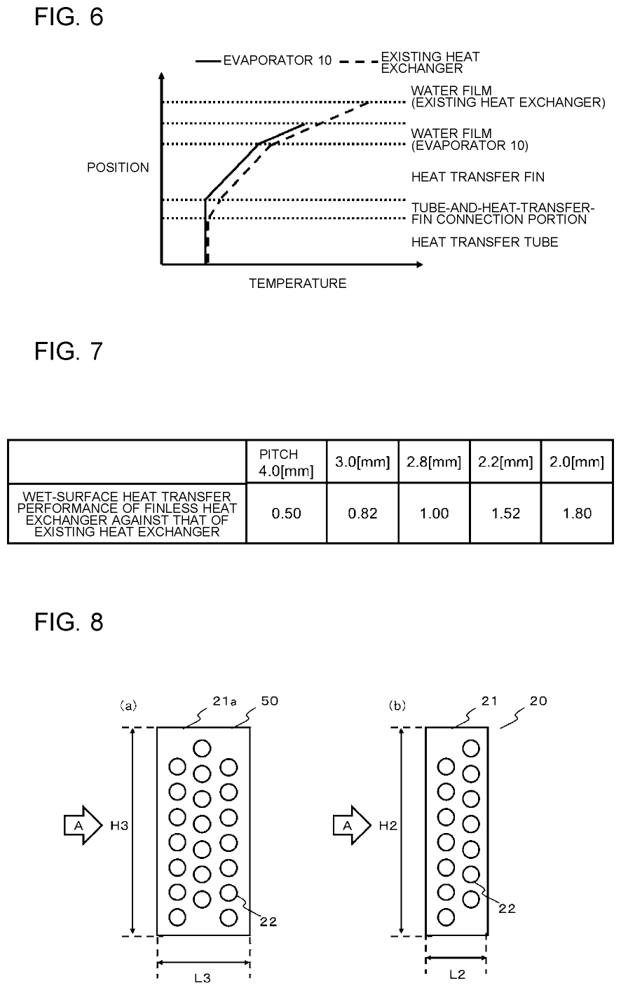

Therefore, the thickness of water films formed on surfaces of the flat tubes 11 and the extension portions 14 in the evaporator 10 is small. As a result, the temperature of a surface of each of the water films is reduced, as compared with an existing heat exchanger. FIG. 6 indicates a comparison between a temperature distribution of the evaporator 10 and that of the existing heat exchanger. It should be noted that the “temperature distribution” means a temperature distribution from the center of a heat transfer tube to a water film on the heat transfer fin through the heat transfer fin. Furthermore, in FIG. 6, it is assumed that the surface temperatures of the flat tube 11 and the circular tube 22 are equal to the temperature of refrigerant that flows in the flat tube 11 and the circular tube 22.

As illustrated in FIG. 6, in the existing heat exchanger, the temperature rises through a tube-and-heat-transfer-fin connection portion, the heat transfer fins, and a thick water film. In contrast, in the evaporator 10, the flat tube 11 and the extension portion 14 can be formed integral with each other, and the value by which the temperature is raised by a tube-extension portion connection is small. Furthermore, in the evaporator 10, since the thickness of the water film is small, the value by which the temperature at the water film rises is small.

For the above reason, in the existing heat exchanger, the difference in temperature between air and the water film on a surface of the evaporator is small and the amount of heat exchange is thus small. In contrast, in the evaporator 10, the difference in temperature between the water film and air is great, and the amount of heat exchange is thus great. In addition, in the evaporator 10, since it is ease to necessarily keep the temperature of the water film lower than or equal to the dew-point temperature of air, water necessarily continues to condense and the evaporator 10 thus exhibits a high dehumidification performance.

In addition, in the evaporator 10, since the thickness of the water film on the surface of the evaporator 10 can be reduced, the flow of air that passes through the evaporator 10 is rarely hindered by the water film. Accordingly, in the evaporator 10, an increase in ventilation resistance on the wet surface is small, and the efficiency of heat exchange between air and the refrigerant is improved.

For the above reasons, the finless heat exchanger that is used as the evaporator 10 is superior in both wet-surface heat transfer performance and pressure loss to the existing heat exchanger. Accordingly, even if the heat transfer area is reduced, a finless heat exchanger such as the evaporator 10 can exhibit a heat exchange performance higher than or equivalent to that of the existing heat exchanger, and the dehumidifying apparatus 100 can exhibit a dehumidification performance higher than or equivalent to that of an existing dehumidifying apparatus. As a result, it is possible to reduce the size of the housing 1 and thus also reduce the size the dehumidifying apparatus.

The dehumidifying apparatus 100 having the above configuration obtains the following advantages. First, since the size of the evaporator 10 can be reduced, the size of the entire dehumidifying apparatus 100 can also be reduced. As a result, the user can install the dehumidifying apparatus 100 in various places. At the same time, since the weight of the dehumidifying apparatus 100 is reduced, the user can easily move the dehumidifying apparatus 100.

Furthermore, the ventilation resistance of the evaporator 10 is lower than the ventilation resistance of the existing heat exchanger. It is therefore possible to reduce noise made by the dehumidifying apparatus 100, and also reduce the possibility that the user will feel annoyed.

In addition, the evaporator 10 has a high drainage performance for letting out condensed water therefrom. Thus, the dehumidifying apparatus 100 has a high dehumidification performance per unit time. Therefore, even if the room has a high humidity, it is possible to reduce the humidity in a short time.

Furthermore, the extension portions 14 of the evaporator 10 include no flow passage 13 for the flow of the refrigerant. Thus, the amount of refrigerant in the evaporator 10 is small, though the heat transfer area of the evaporator 10 is large. It is therefore possible to reduce the amount of refrigerant that is contained in the dehumidifying apparatus 100.

The width W2 of the extension portion 14 is smaller than the width W1 of the flat tube 11. Therefore, the amount of metal material, for example, aluminum, of which the extension portion 14 is made is smaller than the amount of metal material of which a flat tube 11 having the same length as the extension portion 14 is made. It is therefore possible to reduce the cost of manufacturing the dehumidifying apparatus 100, and also to reduce the weight of the dehumidifying apparatus 100, since the amount of aluminum that is used is reduced.

The foregoing description refers to an example of the configuration of the dehumidifying apparatus 100, and the dehumidifying apparatus 100 can be modified variously without departing from the gist of the present disclosure.

For example, in the present embodiment, the condenser 20 is a heat exchanger having one path (the number of times the refrigerant branches off is 1); however, the condenser 20 may be a heat exchanger having two or more paths. In addition, the condenser 20 may be a flat-tube heat exchanger that employs flat tubes as heat transfer tubes. In the case where the condenser 20 is a heat exchanger having two or more paths, it is preferable that the header in which the refrigerant flows into the circular tube be made to have a function of distributing the refrigerant.

Furthermore, although referring to FIG. 3, (c) and (e), the extension portions 14 are provided both on the upstream side and downstream side of the flat tube 11, an extension portion 14 may be provided only either upstream or downstream of the flat tube 11. Furthermore, the length of the extension portion 14 located on the upstream side may be different from that of the extension portion 14 located on the downstream side. In the following description, the extension portion 14 located on the upstream side is referred to as a first extension portion 14a and the extension portion 14 located on the downstream side is referred to as a second extension portion 14b.

In the case where only either the first extension portion 14a or the second extension portion 14b is provided in the evaporator 10, it is preferable that the first extension portion 14a be provided. Regarding the evaporator 10, from a comparison between the temperature of the surrounding air, the temperatures of the first extension portion 14a and the second extension portion 14b, and the temperature of the flat tube 11, it is found that the temperature of the air is the highest, the temperature of each of the first extension portion 14a and the second extension portion 14b is the second highest, and the temperature of the flat tube 11 is the lowest. Therefore, the difference between the temperature of the air and those of the first and second extension portions 14a and 14b is smaller than the difference between the temperature of the air and that of the flat tube 11.

In such a case, even if air and the first extension portion 14a exchange heat with each other in a region located upstream of the flat tube 11 and the temperature of the air decreases, there is still a temperature difference between the air and the flat tube 11. Therefore, both the first extension portion 14a and the flat tube 11 exchange heat with the air. In contrast, in the case where the second extension portion 14b is provided downstream of the flat tube 11, the temperature difference between the second extension portion 14b and the air whose temperature is decreased by heat exchange between the air and the flat tube 11 decreases, and the heat exchange efficiency is reduced. Accordingly, in the case where only either the first extension portion 14a and the second extension portion 14b is provided, it is preferable that the first extension portion 14a be provided, since the dehumidification performance of the dehumidifying apparatus 100 is enhanced as compared with the case where the second extension portion 14b is provided. Similarly, in the case where the first extension portion 14a and the second extension portion 14b have different lengths, it is preferable that the first extension portion 14a be longer than the second extension portion 14b.

Furthermore, the evaporator 10 may be configured such that the flat tubes 11 are arranged in a depth direction. In that case, all of the flat tubes 11 may include extension portions 14, or only one or more of the flat tubes 11 may include extension portions 14. In this case, it is preferable that the extension portion 14 be provided upstream of the most upstream one of the flat tubes 11 in order to ensure the aforementioned temperature difference between the air and the extension portion 14.

Furthermore, the flat tube 11 and the extension portion 14 may be formed integral with each other or may be joined to each boy by brazing. However, unless otherwise restricted, it is preferable that the flat tube 11 and the extension portion 14 may be formed integral with each other for the following reason. In the case where the flat tube 11 and the extension portion 14 are joined to each other by brazing, the joining portion between them may become an obstacle to the heat transfer, thereby degrading the heat transfer performance.

The tube diameter of the header 12b is not limited to a specific one, whereas preferably, the tube diameter of the header 12a should be nearly equal to the depth of the flat tube 11. In this case, the tube diameter of the header 12a is smaller than the depth L1 of the evaporator 10 as illustrated in FIG. 3, (c). By configuring the header 12a in such a manner, it is possible to reduce the amount of refrigerant in the header 12a, thereby reducing the possibility that water that drops from the extension portion 14 will adhere to the header 12a. This reduces the possibility that the user will feel annoyed by water dropping from the header 12a to a storage space of the water storage tank 4, for example, while the user is pouring off water after taking out the water storage tank 4.

In the evaporator 10, it is preferable that the distances between the flat tubes 11 arranged parallel to each other, that is, the pitch between the flat tubes 11, be less than or equal to 2.8 mm. FIG. 7 is a diagram indicating the wet-surface heat transfer performance of a finless heat exchanger with reference to the performance of the existing heat exchanger in the case where the performance of the existing heat exchanger is 1.00. FIG. 7 indicates the wet-surface heat transfer performance of the finless heat exchanger in the case where the pitch between flat tubes 11 varies from 4.0 mm to 2.0 mm.

As indicated in FIG. 7, the wet-surface heat transfer performance of the finless heat exchanger is lower than in the existing heat exchanger in the case where the pitch is greater than 3.0 mm. This is because the number of flat tubes 11 is small, the heat transfer area thus decreases, and the distances between the flat tubes 11 are great, as a result of which the air A does not sufficiently come in contact with the flat tubes 11 or the extension portions 14.

In contrast, referring to FIG. 7, in the case where the pitch between flat tubes 11 is less than 3.0 mm, the wet-surface heat transfer performance of the finless heat exchanger is superior to that of the existing heat exchanger. From a linear interpolation (Formula 1) based on a wet-surface heat transfer performance of 0.82 in the case where the pitch is 3.0 mm and a wet-surface heat transfer performance of 1.52 in the case where the pitch is 2.2 mm, it can be assumed that the finless heat exchanger exhibits a performance that is substantially equivalent to that of the existing heat exchanger in the case where the pitch is less than or equal to 2.8 mm, although the inventors did not make a measurement in the case where the pitch is 2.8 mm. Therefore, in the present embodiment, it is preferable that the pitch between the flat tubes 11 be smaller than or equal to 2.8 mm.

0.82+(1.52−0.82)/(30−22)×2=1 (1)

It should be noted that needless to say, even if the pitch is less than or equal to 2.8 mm, when the pitch is 0 mm, air does not flow between the flat tubes 11 and dehumidification is not performed.

Furthermore, it can be seen from FIG. 7 that since the wet-surface heat transfer performance of the evaporator 10 is high when the pitch between flat tubes 11 is small, the dehumidification performance of the dehumidifying apparatus can be maintained even when the heat transfer area of the evaporator 10 is decreased. As a result, it is possible to make the dehumidifying apparatus 100 smaller while maintaining the dehumidifying performance. This point will be described.

Referring to FIG. 3, (c), L1 is the depth of a combination of the extension portion 14 and the flat tube 11 of the evaporator 10, H1 is the height of the extension portion 14 and the flat tube 11, L2 is the depth of the heat transfer fin 21 of the condenser 20, and H2 is the height of the heat transfer fin 21.

The heat transfer area of the evaporator 10 and the heat transfer area of the condenser 20 will be described. As illustrated in FIG. 3, (c) and (e), the heat transfer area of the evaporator 10 is the sum of the surface area of the flat tube 11 and the surface area of the extension portion 14. It should be noted that the depth L1 of the extension portion 14 and the flat tube 11 is several times greater than the width W1 of the flat tube 11 and the width W2 of the extension portion 14. Therefore, the heat transfer area of the evaporator 10 can be deemed as the size of a surface parallel to the flow direction of air, and is expressed by the product of H1 and L1.

The heat transfer area of the condenser 20 is the sum of the surface area of the heat transfer fin 21 and the surface area of the circular tube 22. In a fin and tube heat exchanger such as the condenser 20, the surface area of a heat transfer fin is generally several to several tens of times greater than the surface area of the circular tube. Furthermore, the heat transfer fin is generally a metal plate whose thickness is less than 1 mm. Therefore, the heat transfer area of the condenser 20 can be deemed as the size of a surface parallel to the flow direction of air through the heat transfer fin 21, and is expressed by the product of H2 and L2.

Furthermore, the heat transfer area of the evaporator 10 and the heat transfer area of the condenser 20 will be described with reference to the structure of the existing dehumidifying apparatus. FIG. 8 illustrates configurations of an evaporator and a condenser in an existing dehumidifying apparatus. Since the condenser is also a fin and tube heat exchanger in the existing dehumidifying apparatus, referring to FIG. 8, the condenser 20 according to the present embodiment is used.

As illustrated in FIG. 8, in the existing dehumidifying apparatus, the evaporator 50 and the condenser 20 are both fin and tube heat exchangers. The evaporator 50 and the condenser 20 are the same as each other in the tube diameter and tube thickness of the circular tubes 22, the number of stages at which the circular tubes 22 are provided, the row pitch, the stage pitch, the fin thickness and height of the heat transfer fins 21 and heat transfer fins 21a. Furthermore, the evaporator 50 and the condenser 20 are also the same as each other in stacking width. The evaporator 50 and the condenser 20 are different from each other as follows: the number of circular tubes 22 in each row in the evaporator 50 is 3 and that of circular tubes 22 in each row in the condenser 20 is 2, and as a result, the depth L3 of the heat transfer fin 21a is approximately 1.5 times greater than the depth L2 of the heat transfer fin 21.

Referring to FIG. 7, in the case where the pitch is less than or equal to 2.8 mm, the finless heat exchanger exhibits a higher wet-surface performance than the existing heat exchanger. Furthermore, in the case where the pitch is less than or equal to 2.2 mm, the finless heat exchanger exhibits a wet-surface performance that is 1.5 or more times higher than that of the existing heat exchanger.

Therefore, it is possible to reduce the heat transfer area to 1/1.5 by replacing the evaporator 50, which is mounted in the existing dehumidifying apparatus, with a finless heat exchanger, such as the evaporator 10, in which the pitch is less than or equal to 2.2 mm. It should be noted that since in the existing dehumidifying apparatus, the heat transfer area of the evaporator 50 is 1.5 times larger than that of the condenser 20, and it is therefore possible to keep the dehumidifying performance at a value that is nearly equal to that of the existing dehumidifying apparatus, by replacing the evaporator 50 in the existing dehumidifying apparatus with the evaporator 10 and causing the heat transfer area of the evaporator 10 to be substantially equivalent to that of the condenser 20.

In the case of changing the heat transfer area of the evaporator 10, it is more preferable to change the depth L1, not the height H1 of the evaporator 10. In the dehumidifying apparatus 100, if the height H1 of the evaporator 10 and the height H2 of the condenser 20 greatly differ from each other, a wasted space is provided in the housing 1. Therefore, it is preferable to change the depth L1 to adjust the heat transfer area of the evaporator 10. Furthermore, according to FIG. 7, it is also possible to make the depth L1 less than or equal to the depth L2 of the condenser 20 if the pitch in the evaporator 10 is less than or equal to 2.2 mm.

In such a manner, by reducing the heat transfer area of the evaporator 10, it is possible to further reduce the size of the housing 1 and thus also reduce the size of the dehumidifying apparatus 100. In particular, it should be noted that by making the depth L1 of the evaporator 10 less than the depth L2 of the condenser 20, it is possible to reduce the possibility that the performance of the condenser will fall below the performance of the evaporator, and thus reduce the possibility that the temperature in the room will be decreased during operation of the dehumidifying apparatus 100 and the comfort will be impaired.

### Embodiment 2

### Configuration of Dehumidifying Apparatus

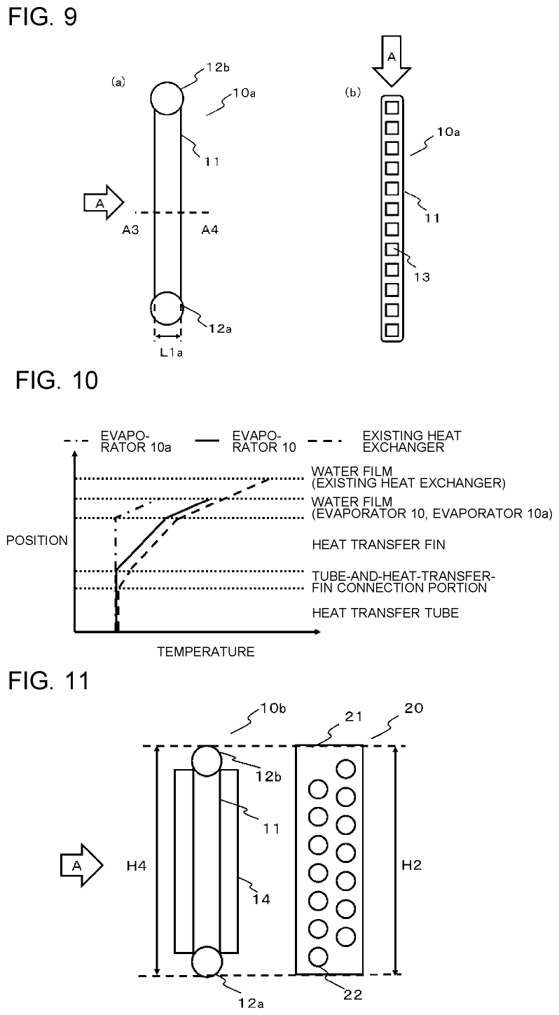

Embodiment 2 of the present disclosure will be described with reference to FIGS. 9 and 10. A dehumidifying apparatus 100a according to Embodiment 2 is substantially the same in configuration as the dehumidifying apparatus 100 of Embodiment 1, but is different in shape of the evaporator from the dehumidifying apparatus 100 of Embodiment 1. The following description concerning the dehumidifying apparatus 100a according to Embodiment 2 is made by referring mainly to the differences between Embodiments 1 and 2. Regarding Embodiment 2, components that will not be described are the same as those in Embodiment 1.

FIG. 9, (a), is a side view of an evaporator 10a according to Embodiment 2, and FIG. 9, (b), is a cross-sectional view taken along line A3-A4. The evaporator 10a of Embodiment 2 includes no extension portions 14. In this regard, the evaporator 10a of Embodiment 2 is different from the evaporator 10 of Embodiment 1. To be more specific, the evaporator 10a includes the flat tubes 11, the header 12a, and the header 12b. It should be noted that the condenser 20 of Embodiment 2 is the same in configuration as the configuration to the condenser 20 of Embodiment 1.

The heat transfer performance of the evaporator 10a will be described. FIG. 10 is a diagram indicating a temperature distribution of the evaporator 10a. The “temperature distribution” means a temperature distribution from the center of a heat transfer tube to a water film, as in FIG. 6. Furthermore, FIG. 10 also indicates both a temperature distribution of the existing heat exchanger and a temperature distribution of the evaporator 10.

The evaporator 10a includes no extension portion 14 and include the flat tubes 11 only. Thus, needless to say, the temperature does not rise at an extension portion 14, and does not rise at a tube-extension portion connection. Therefore, in the evaporator 10a, the temperature rises at the water film only. Therefore, the temperature of the water film in the evaporator 10a is lower than in the existing heat exchanger and the evaporator 10.

Therefore, the evaporator 10a is superior to the evaporator 10 in wet-surface heat transfer performance. In other words, in the evaporator 10a, since the temperature of air and that of the water film are greatly different from each other, the amount of heat exchange is large and the amount of water that condenses per unit time is large.

The dehumidifying apparatus 100a as described above obtains the following advantages, in addition to the advantages of the dehumidifying apparatus 100 of Embodiment 1.

The condenser 10a is superior in wet-surface heat transfer performance to the evaporator 10, and can thus dehumidify the room in a shorter time.

### Embodiment 3

### Configuration of Dehumidifying Apparatus

Embodiment 3 of the present disclosure will be described with reference to FIG. 11. A dehumidifying apparatus 100b of Embodiment 3 is substantially the same in configuration as the dehumidifying apparatus 100 of Embodiment 1, but includes an evaporator that is different in shape form the evaporator in the dehumidifying apparatus 100 of Embodiment 1. The following description concerning the dehumidifying apparatus 100b according to Embodiment 3 is made by referring mainly to the differences between Embodiments 1 and 3. Regarding Embodiment 3, components that will not be described are the same as those of Embodiment 1.

FIG. 11 illustrates configurations of an evaporator 10b and the condenser 20 according to Embodiment 3. In Embodiment 3, the configuration of the evaporator 10b is substantially the same as that of the evaporator 10 of Embodiment 1, and the evaporator 10b includes flat tubes 11, a header 12a, a header 12b, and extension portions 14.

In FIG. 11, H4 is the height of the evaporator 10b, and H2 is the height of the condenser 20. More specifically, H4 is the length of the evaporator 10b from a lower end of the header 12a to an upper end of the header 12b, and H2 is the length from a lower end of the heat transfer fin 21 to an upper end of the heat transfer fin 21.

In Embodiment 3, the height H4 of the evaporator 10b is less than or equal to the height H2 of the condenser 20. It should be noted that FIG. 11 illustrates the case where the height H4 of the evaporator 10b is equal to the height H2 of the condenser 20. More specifically, the lower end of the header 12a of the evaporator 10b is located at the same level as the lower end of the heat transfer fin 21 of the condenser 20, and the upper end of the header 12b is located at the same level as the upper end of the heat transfer fin 21.

In the dehumidifying apparatus 100b, since the height of the evaporator 10b is restricted, the heat transfer area of the evaporator 10b is made smaller. However, the evaporator 10b is superior in wet-surface heat transfer performance to the existing heat exchanger for the same reason as described regarding Embodiment 1. In addition, in the evaporator 10b, the air A also collides with the headers 12a and 12b through which low-temperature refrigerant flows. Therefore, also, at surfaces of the headers 12a and 12b, the air A and the refrigerant exchange heat with each other. For the above two reasons, the dehumidifying apparatus 100b can exhibit a dehumidification performance that is higher than or equivalent to the existing dehumidifying apparatus, though even if the height of the evaporator 10b is restricted.

Furthermore, the positions of the headers 12a and 12b of the evaporator 10b and that of the header 24 of the condenser 20 will be described. The headers 12a and 12b of the evaporator 10b are attached to upper and lower ends of each of the flat tubes 11, respectively. The header 24 of the condenser 20 is connected to one end of each of the circular tubes 22 in a lateral direction. That is, the evaporator 10b and the condenser 20 differ from each other in the direction in which the headers are attached.

The case where a region occupied by the flat tubes 11 (specifically, a region between upper and lower ends of flat tubes 11 in a region between the rightmost one of the flat tubes 11 and the leftmost one of the flat tubes 11 as illustrated in FIG. 3, (a), and within the upper and lower ends of the flat tubes 11) and a region occupied by the heat transfer fins 21 are the same as each other as seen in the flow direction of air will be referred to. In this case, portions that contribute to a heat exchanger are not present in a region located downstream of the headers 12a and 12b of the evaporator 10b and upstream of the header 24. Thus, a wasted space is created in the housing 1.

Therefore, it is preferable to eliminate the wasted space in order to reduce the size of the housing 1. In Embodiment 3, since the height H4 of the evaporator 10b is less than or equal to the height H2 of the condenser 20, the heat transfer fins 21 of the condenser 20 are located behind the headers 12a and 12b. In addition, since the evaporator 10b is a finless heat exchanger that is superior in wet-surface heat transfer performance, the size of the housing 1 of the dehumidifying apparatus 100b can be reduced and in addition, the dehumidifying performance is kept high.

The dehumidifying apparatus 100b as described above obtains the following advantages in addition to the advantages of the dehumidifying apparatus 100 of Embodiment 1. Since the height of the evaporator 10b is less than or equal to the height of the condenser 20, a wasted space is not easily created in the housing 1. It is therefore possible to reduce the size of the housing 1 and also reduce the size of the dehumidifying apparatus 100b.

The above description is made to explain an example of the configuration of the dehumidifying apparatus 100b, and the dehumidifying apparatus 100b may be variously modified without departing from the gist of the present disclosure.

It is preferable that the tube diameters of the headers 12a and 12b be nearly equal to the depth of the flat tube 11, that is, the diameter of the flat tube 11. This is because that when the tube diameters of the headers 12a and 12b are small, water does not easily collect in the headers 12a and 12b and the thickness of the water film decreases, whereby the heat exchange efficiency at the headers 12a and 12b thus increase.

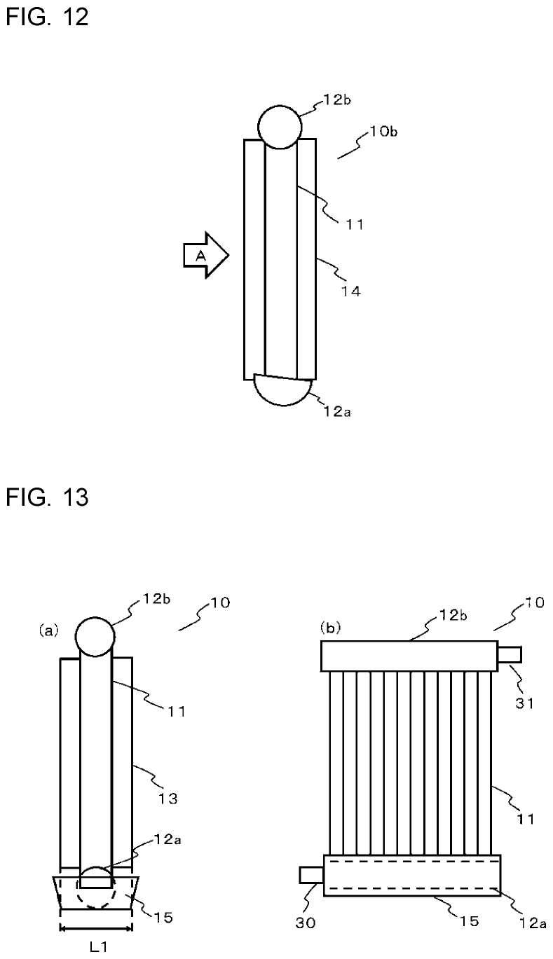

The headers 12a and 12b may be changed in shape to enable drainage to be easily performed. FIG. 12 is a side view of the evaporator 10b in the case where the header 12a is changed in shape to enable drainage to be easily performed. In the present modification, as illustrated in FIG. 12, the header 12a has a semicircular section.

In addition, since a linear portion of the header 12a having the semicircular cross section is located on an upper side of the header 12a and is inclined, condensed water stored in upper part of the header 12a is promptly let out along the inclination. In Embodiment 3, since heat exchange is also performed at the header 12a, it is possible to increase the heat exchange efficiency at the header 12a by promptly letting out water adhering to the header 12a. It is therefore also possible to efficiently perform dehumidification in the header 12a, thereby improving the dehumidification performance of the dehumidifying apparatus 100b. Although the above description refers to an example in which the shape of the header 12a is changed, the shape of the header 12b can also be changed in such a manner as described above.

### Embodiment 4

### Configuration of Dehumidifying Apparatus

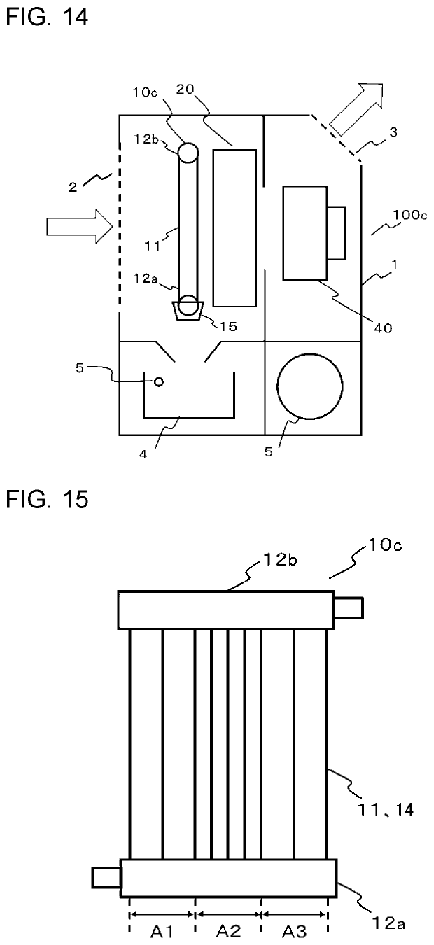

Embodiment 4 of the present disclosure will be described with reference to FIGS. 13 and 14. A dehumidifying apparatus 100c according to Embodiment 4 is substantially the same in configuration as the dehumidifying apparatus 100 of Embodiment 1, but includes an additional component not included in the dehumidifying apparatus 100 of Embodiment 1. The following description concerning the dehumidifying apparatus 100c of Embodiment 4 is made by referring mainly to the differences between Embodiments 1 and 4. Regarding Embodiment 4, components that will be not described are the same as those of Embodiment 1.

FIG. 13, (a), is a side view of the evaporator 10 according to Embodiment 4, and FIG. 13, (b), is a front view of the evaporator 10 according to Embodiment 4. In Embodiment 4, a water conduit 15 is provided in lower part of the evaporator 10.

The water conduit 15 has a trapezoidal section. The length of the water conduit 15 is nearly equal to the length of the header 12a in the lateral direction. The water conduit 15 has openings in its upper and lower parts. Furthermore, the width of the opening in the upper part of the water conduit 15 is greater than the depth L1 of the evaporator 10. The water conduit 15 is provided such that at least part of the header 12a is accommodated in an internal space of the water conduit 15.

The water conduit 15 has a function of receiving condensed water that drops from the evaporator 10 and of guiding the condensed water to the water storage tank 4. FIG. 14 illustrates the configuration of the dehumidifying apparatus 100c of Embodiment 4. As illustrated in FIG. 14, the water conduit 15 is located above the water storage tank 4. Thus, the condensed water received by the water conduit 15 is let out from the water conduit 15 into the water storage tank 4 through the opening in the lower part of the water conduit 15.

The dehumidifying apparatus 100c having the above configuration obtains the following advantages. Since the water conduit 15 is provided in lower part of the evaporator 10, there is little likelihood that condensed water that drops from the evaporator 10 will fly off, and it is possible to keep the inside of the apparatus clean.

Furthermore, since the water conduit 15 accommodates part of the header 12a, space savings in the housing 1 is achieved. It is therefore possible to reduce the size of the dehumidifying apparatus 100c.

### Embodiment 5

Embodiment 5 of the present disclosure will be described with reference to FIG. 15. A dehumidifying apparatus 100d according to Embodiment 5 is substantially the same in configuration as each other, but the configuration of an evaporator of Embodiment 5 is different from the configuration of the evaporator in the dehumidifying apparatus 100 of Embodiment 1. The following description concerning the dehumidifying apparatus 100d according to Embodiment 5 is made by referring mainly to the differences between Embodiments 1 and 5. Regarding Embodiment 5, components that will not be described are the same as those of Embodiment 1.

FIG. 15 illustrates a configuration of an evaporator 10c according to Embodiment 5. In Embodiment 5, the evaporator 10c includes a region in which flat tubes 11 are arranged at a small pitch and at a high density and a region in which flat tubes 11 are sparsely arranged at a great pitch and at a low density. For example, referring to FIG. 15, three regions A1, A2, and A3 are provided. In the regions A1 and A3, flat tubes 11 are arranged at a great pitch and a low density, and in the region A2, flat tubes 11 are arranged at a small pitch and a high density.

In a configuration in which holes formed in heat transfer fins formed in the shape of a thin plate and teat transfer tubes are made to extend thorough the holes as in an existing heat exchanger, the pitch cannot be easily locally changed. In contrast, in the finless heat exchanger, since it is not subject to the above restriction, it is possible to comparatively freely change the pitch as in the configuration as illustrated in FIG. 15.

When the air A flows in the evaporator 10c, in the regions A1 and A3 in which the pitch between flat tubes 11 is great, the wet-surface heat transfer performance is degraded and the amount of heat exchange is thus decreased. In contrast, in the region A2 in which flat tubes 11 are arranged at a small pitch and a high density, the wet-surface heat transfer performance is high and the amount of heat exchange is thus increased. In particular, when the pitch between flat tubes 11 is less than or equal to 2.2 mm, the evaporator 10 exhibits a wet-surface heat transfer performance that is 1.5 times or more higher than that of the existing heat exchanger. Thus, in some flat tubes, even when the pitch is increased, it is possible to maintain a heat exchange amount that is larger than or equal to that of the existing heat exchanger.

Furthermore, referring to FIG. 15, flat tubes 11 are arranged at a high density at a central region of the evaporator 10c and in the vicinity of the central region for the following reason: generally, in the case where a heat exchanger and a blower are arranged side by side as illustrated in FIG. 2, the volume of air in the vicinity of a central region of the heat exchanger is large and the volume of air on an outer side of the heat exchanger is small. By providing flat tubes 11 at the central region of the evaporator 10c and in the vicinity of the central region at a high density, the dehumidification efficiency at the central region and in the vicinity thereof is increased and it is therefore possible to increase the amount of dehumidification by the dehumidifying apparatus 100d.

It should be noted that the distribution of the volumes of air on the heat exchanger varies depending on the characteristics of the blower and the positional relationship between the heat exchanger and the blower. For example, contrary to the above example, in some cases, the volume of air on the outer side of the heat exchanger is large and the volume of air at the central region and in the vicinity thereof is small. In this case, in the evaporator 10c, flat tubes 11 on the outer side are arranged at a high density, and flat tubes 11 at the central region and in the vicinity thereof are arranged at a low density. Also, in cases other than the above case, it is preferable to change the density of the flat tubes 11 as appropriate depending on the distribution of the volumes of air on the heat exchanger.

The dehumidifying apparatus 100d as described above obtains the following advantages. Since the evaporator 10c is made to include a region in which flat tubes 11 are arranged at a low density, the weight of the evaporator 10c is decreased accordingly and the weight of the dehumidifying apparatus 100d is also decreased.

Furthermore, the ventilation resistance of the evaporator 10c is low, especially in a region in which flat tubes 11 are arranged at a low density. As a result, noise made in the dehumidifying apparatus 100d is reduced, thereby reducing the possibility that the user will feel annoyed.

The above description refers to an example of the configuration of the dehumidifying apparatus 100d, and the dehumidifying apparatus 100d can be variously modified without departing from the gist of the present disclosure.

For example, in Embodiment 5, the region A2 in which flat tubes 11 are arranged at a high density, and the regions A1 and A3 in which flat tubes 11 are arranged at a low density, are provided. However, it is not indispensable that the region in which flat tubes 11 are arranged at a low density is provided. That is, it suffices that in part of the evaporator 10c, flat tubes 11 are arranged at a high density. It is allowable that in other parts of the evaporator 10c, flat tubes 11 are not provided. Even in such a configuration, dehumidification is performed intensively in the region in which flat tubes 11 are arranged at a high density, whereby the dehumidification performance of the dehumidifying apparatus 100d is maintained.

### INDUSTRIAL APPLICABILITY

A dehumidifying apparatus of the present disclosure is applicable to dehumidification regardless of the dimensions of the room, the usage of the room, and other conditions.

1. A dehumidifying apparatus comprising:
a housing;
an air inlet provided in the housing;
an air outlet provided in the housing;
a blower provided in the housing; and
an evaporator provided on an air passage that connects the air inlet and the air outlet, and configured to cool and dehumidify air that is sent into the housing by the blower,
wherein the evaporator includes
a plurality of flat tubes having flow passages through which refrigerant flows and extending in an up-down direction,
a pair of headers connected to an upper end and a lower end of each of the flat tubes,
a first extension portion connected to a windward side of one of the flat tubes, and having long sides extending in the up-down direction along of the flat tube, and
a distance between any adjacent two of the flat tubes is less than or equal to 2.8 mm and greater than or equal to 2.0 mm.

2. The dehumidifying apparatus of claim 1, further comprising a second extension portion connected to a leeward side of the flat tube, and extending in the up-down direction along the flat tube.

3. The dehumidifying apparatus of claim 2, wherein a width of the first extension portion and a width of the second extension portion are smaller than a width of the flat tube.

4. The dehumidifying apparatus of claim 2, wherein in a depth direction of the evaporator, the first extension portion is longer than the second extension portion.

5. The dehumidifying apparatus of claim 1, wherein a diameter of the header connected to the lower end of the flat tube is smaller than a distance from a windward end of the first extension portion to a leeward end of the flat tube in a depth direction of the evaporator.

6. The dehumidifying apparatus of claim 2, wherein a diameter of the header connected to the lower end of the flat tube is smaller than a distance from a windward end of the first extension portion to a leeward end of the second extension portion in a depth direction of the evaporator.

7. The dehumidifying apparatus of claim 1, further comprising a condenser provided downstream of the evaporator on the air passage connecting the air inlet and the air outlet and configured to heat the air that is cooled and dehumidified by the evaporator,
wherein
the condenser includes
a refrigerant pipe through which the refrigerant flows, and
a heat-transfer accelerator connected to the refrigerant pipe and configured to accelerate heat exchange between a fluid passing through the condenser and a fluid flowing through the refrigerant pipe, and
a distance between an upper end of the header connected to the upper end of the flat tube and a lower end of the header connected to the lower end of the flat tube is less than or equal to a length of the heat-transfer accelerator of the condenser in the up-down direction.

8. The dehumidifying apparatus of claim 1, further comprising:
a water storage tank provided below the evaporator; and
a water conduit configured to receive water that drops from the evaporator and guide the water to the water storage tank,
wherein at least part of the header connected to the lower end of the flat tube is provided inside the water conduit.

9. (canceled)

10. The dehumidifying apparatus of claim 1,
wherein a distance between any adjacent two of the flat tubes is smaller than or equal to 2.2 mm,
the dehumidifying apparatus further comprising a condenser provided downstream of the evaporator on the air passage connecting the air inlet and the air outlet and configured to heat the air that is cooled and dehumidified by the evaporator,
wherein
the condenser includes
a refrigerant pipe through which the refrigerant flows, and
a heat-transfer accelerator connected to the refrigerant pipe and configured to accelerate heat exchange between a fluid passing through the condenser and a fluid flowing through the refrigerant pipe, and
a length of the evaporator in a depth direction is smaller than a length of the heat-transfer accelerator of the condenser in the depth direction.

11. The dehumidifying apparatus of claim 1, wherein in the evaporator, a first region and a second region are provided in a lateral direction of the evaporator, the first region being a region in which a distance between any adjacent two of the flat tubes is small, the second region being a region in which a distance between any adjacent two of the flat tubes is greater than the distance between any adjacent two of the flat tubes in the first region.

12. (canceled)

13. A dehumidifying apparatus comprising:
a housing;
an air inlet provided in the housing;
an air outlet provided in the housing;
a blower provided in the housing; and
an evaporator provided on an air passage that connects the air inlet and the air outlet and configured to cool and dehumidify air that is sent into the housing by the blower,
wherein
the evaporator includes
a plurality of flat tubes having flow passages through which refrigerant flows and extending in an up-down direction, and
a pair of headers connected to an upper end and a lower end of each of the flat tubes, the evaporator has long sides extending in a direction crossing a direction in which the flat tubes extend,
the evaporator is not provided with a heat-transfer accelerator configured to accelerate heat exchange between a fluid passing through between the flat tubes and a fluid flowing through the flat tubes,
a distance between any adjacent two of the flat tubes is less than or equal to 2.8 mm and greater than or equal to 2.0 mm.
